(19) United States
(12) Patent Application Publication
(10) Pub. No.: US 2004/0267557 A1
(43) Pub. Date: Dec. 30, 2004

(54) [ELECTRONIC DATA MANAGEMENT SYSTEM AND METHOD USING REMOTE SYNCHRONIZED BACKUP TECHNIQUE FOR SPECIALIZED OUTSOURCING]

(76) Inventors: Ivan Liu, Taipei (TW); Wayen Chang, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/710,073

(22) Filed: Jun. 17, 2004

(30) Foreign Application Priority Data
Jun. 17, 2003 (TW) 92116461

(51) Int. Cl. G06F 17/60

(52) U.S. Cl. 705/1

(57) ABSTRACT

An electronic data management (EDM) system and a method using remote synchronized backup technique for outsourcing professional services is provided. In the present invention, a paper or electronic document from a service client is converted into an electronic document that conforms to any e-mail encoding protocols, and is transmitted to a main server of a service provider. The documents are categorized and stored by the e-mail addresses assigned to the document and are thus ready to be accessed by authorized users.

### CROSS REFERENCE TO RELATED APPLICATIONS

This application claims the priority benefit of Taiwan application serial no. 92116461, filed on Jun. 17, 2003.

### BACKGROUND OF INVENTION

1. Field of Invention

The present invention relates to a method for outsourcing professional services, and more particularly, to an electronic data management (EDM) system and method using remote synchronized backup technique for outsourcing professional services.

2. Description of the Related Art

It is a significant and challenging task to fully control the internal management of an organized company. To detect problems that may arise in advance in the enterprise's activities, and to ensure the potential issues in business activities be treated accordingly and promptly, it is fairly important to foresee a problem, propose a solution to unexpected problems in advance, and summarize all relevant data for the policymaker's reference when the problem does arise. Some enterprises are required to keep a major budget for contract management, compliance of laws, internal control compliance plan, accounting, document filing management, human resource evaluation, and research and development. However, under the most common company structure, the company has to either outsource professional service providers (i.e. attorneys-at-law, certified public accountant firm, or business consulting firm), or establish an internal division to deal with the various problems of special significance. However, there are pros and cons for both options. While an internal department facilitates the more efficient flow of internal activities, it also requires higher personnel costs as compared to the outsourcing option. Moreover, in the majority of small or medium enterprises, it is simply not easy to create an internal division that meets a certain standard. It is neither easy to retain qualified division supervisors or distinguished employees to work for the long term. It is thus more difficult to improve the quality of professional services. On the other hand, a fully outsourcing mechanism is usually advantageous because of its lower cost, higher quality, and more stable service performance. However, the flow of internal activities, performance and-supervision is more likely to be less efficient.

In addition, the flow and processing of documents is always a major issue in either of the above treatments of professional services. In order to spot an issue in advance, it is necessary to verify the contents of each document in which such issues may arise. It is referred as the design of “control point” of the internal control system in company management. Practically speaking, a mail room personnel or a secretary is simply not capable of identifying a potential issue of special significance in an incoming document, but if a professional personnel must review and filter all incoming documents, it would apparently result in the unnecessary and lengthy circulation and pileup of documents. Even if the document verification and filtering can be accomplished through outsourcing, it is still not practical due to the cumbersome circulation of documents, the delay in time, and potential loss of documents.

### SUMMARY OF INVENTION

The present invention provides a method for outsourcing professional services using the remote synchronized backup technique that can be utilized between any service client which receives professional consulting services and the service provider which provides the professional consulting services. The service client is only required to set up a computer running on any operating system, Internet connection, a browser installed on the system, and a scanner. On the other hand, the service provider needs to set up a main server for receiving and processing electronic documents, so that all service clients can store or retrieve data on and from the main server. The method for outsourcing professional services using remote synchronized backup technique firstly converts a paper document from the service client into an eleprogressprogressctronic document which conforms to a compliant e-mail encoding protocol, and transmits and stores the electronic document to the main server. The transmitted electronic documents are stored in a file folder with a corresponding e-mail address, so that the service provider or other authorized users can retrieve the document.

In accordance with a preferred embodiment of the present invention, the service client can also configure a dedicated local server on their Local Area Network (LAN) to process electronic documents. In the present embodiment, the main server configured on the service provider's end is synchronized with the local server at any time.

In accordance with another preferred embodiment of the present invention, the main server generates a corresponding e-mail address whenever a file folder is created. In this preferred embodiment of the present invention, a backup server is further provided for a complete backup of the data stored on the main server, and the backup server makes all electronic documents and data accessible in the event that the main server becomes inaccessible.

In accordance with another preferred embodiment of the present invention, the remote main server and the local server are further synchronized in order to ensure data consistency. For example, while the data in the file folder of main server is being updated by a user, the corresponding data in the local server is updated simultaneously.

The present invention further provides an electronic data management (EDM) system comprising of a local server and a remote main server. The local server processes electronic documents which conform to any e-mail encoding protocol, while the main server receives the electronic documents sent by a personal terminal or a server on the network of the service client and files the electronic documents to corresponding folders according to the recipient addresses.

Since all electronic documents in the present invention are delivered via a public electronic mail encoding protocol, it is not necessary to install any software application on the client's terminal, except a scanner and a corresponding device driver for transforming printed materials into electronic documents. The clients are free to use or develop any software programs that conform to any e-mail encoding protocol and transfer protocol. In addition, an electronic document is easily stored and sent promptly to an unlimited number of recipients, thereby eliminating the inconvenience of conventional postal service, photocopy, or facsimile transmission. The present invention essentially provides an internal document management mechanism, which facilitates the prompt provision of consultation services, therefore allowing the clients to immediately handle all issues of professional significance.

### BRIEF DESCRIPTION OF DRAWINGS

FIG. 1 is a schematic system configuration block diagram of an electronic data management (EDM) system using synchronized backup technique for outsourcing professional services of a preferred embodiment according to the present invention.

FIG. 2 is a schematic system configuration block diagram of an electronic data management (EDM) system using remote synchronization backup technique with additional servers for outsourcing professional services of another preferred embodiment according to the present invention.

FIG. 3 schematically shows a flow chart illustrating a method using remote synchronized backup technique for outsourcing professional services of a preferred embodiment according to the present invention.

FIG. 4 schematically shows a flow chart illustrating a corresponding method between an e-mail address and a file folder performed by a preferred embodiment according to the present invention.

### DETAILED DESCRIPTION

In order to solve the problems involved in the prior art, one way is to adopt any electronic document management (EDM) system that is currently available. However, the EDM systems currently available all use a proprietary protocol. In other words, in these EDM systems, the clients must install on their terminals specific software application, which use specific transfer protocols and document formats. Any transfer protocol and electronic document format that do not conform to the specific protocol and format will not be recognized or accepted by the system.

Therefore, the present invention improves the proprietary configuration applied in the prior art. It not only converts the entire system to an open system, but also provides additional functions that the current EDM systems are not capable of.

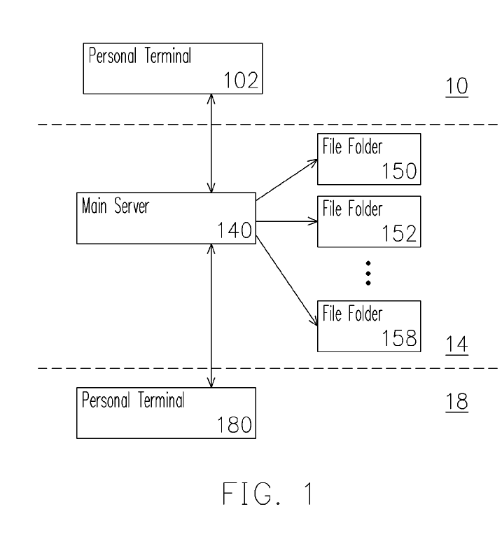

Referring to FIG. 1, it illustrates a system configuration block diagram of an electronic data management (EDM) system using remote synchronized backup technique for outsourcing professional services based on a preferred embodiment of the present invention. In the present embodiment, the EDM system mainly comprises of a personal terminal 102 configured on a client network 10, and a main server 140 configured on the service provider network 14. For the service provider 14, its main server 140 can be connected to a plurality of client network 10. On the client network 10, the electronic document transmitted by the personal terminal 102 (including a personal computer, a portable computer, or a personal digital assistant, and other devices) is directly transmitted to the main server 140 by e-mail delivery. Note that such electronic document is compatible with e-mail encoding protocols that can be recognized by the email client. The personal terminal 102 on the client network 10 only requires the installation of an e-mail client or a web browser which comes with the operating system, so that it may connect to the main server 140 and retrieve the electronic documents stored thereon. Comparing to the proprietary EDM systems used in the prior art, the open configuration used on the client network 10 in the present embodiment differs significantly from the conventional proprietary EDM systems.

As to the service provider 14, the main server 140 receives electronic documents from the personal terminal 102, the local server 104, or other e-mail servers (e.g. SMTP, IMAP, or HTTP servers,) and stores the electronic documents on one of the file folders 150˜158 based one the recipients' addresses, including the addressees' titles and other information. In other words, each of the file folder among folders 150˜158 in the EDM system corresponds to a specific e-mail address in the present embodiment. To implement this function in the preferred embodiment, a specific and unique e-mail address is assigned to the file folder respectively p20p20when each of the file folders 150˜158 is created. Under this implementation, the service provider can easily distinguish among the data from different clients and even the data from different departments or different file folders for the same client. For both the service provider 14 and the client 10, the system provides a fairly convenient and automated method of document filing.

Furthermore, in order to fulfill meet the clients' need for mobility, the client is allowed to access the data on the main server 140 from any other external environment 18 such as personal terminal 180 via e-mail transmission.

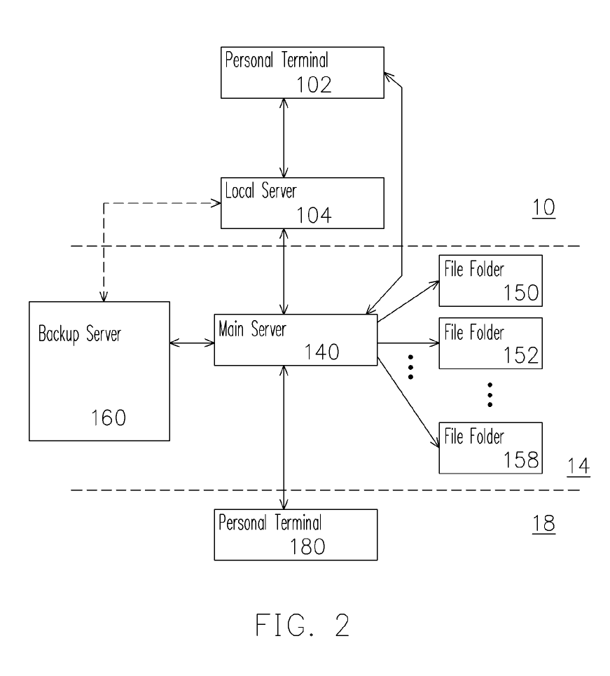

Referring to FIG. 2, it illustrates a system configuration block diagram of another preferred embodiment based on the present invention, wherein the similar devices as to FIG. 1 follow identical reference numbers. In the present embodiment, the EDM system mainly comprises of a local server 104 and a main server 140. The local server 104 is set up on the client's end 10, and the main server 140 is configured on the service provider's end 14. For the same service p22p22provider, its main server 140 possibly connects to multiple local servers similar to terminal 104 and accesses all data stored in local servers.

In the present embodiment, the main server 10 on the client's end has two ways to update the data to main server 14010. One of the options is where the personal terminal 102 directly transmits electronic documents via e-mail to the main server 140, and the main server 140 saves the mail in the corresponding file folders 150˜158 upon receipt. The data on the main server 140 and the local server 104 are then synchronized. The otheroption is that the local server 104 receives electronic documents through any one of the personal terminals similar to terminal 102 (comprising of a personal computer, a portable computer, or a personal digital assistant, etc.) on client network LAN 10. The local server 104 and the main server 140 are then synchronized to ensure consistency in the data stored on both ends.

It is similar to the foregoing embodiment that in this preferred embodiment, an electronic document must comply with an e-mail encoding protocol and the personal terminal 102 must be equipped with an e-mail client or web browser that comes with any operating system in order to connect to local server 104 and retrieve the data stored thereon.

Compared to the preferred embodiment shown in FIG. 1, the set up of local server 104 on the client network 10 mainly serves to increase the data retrieval speed for the personal terminal 102 of the service client (under the currently available structure of enterprise LAN, the transmission rate is not lower than 10 Mbps, or even as high as 1 Gbps, with either cable or wireless connection, which is far beyond the broad band internet connections that most enterprises currently utilize). Moreover, local server 104 allows access from the personal terminal 102 when the Internet is inaccessible to the service client. Besides, the local server 104 and the main server 140 are synchronized to ensure that the data on local server 104 is always backed up on the main server 140.

Since the present invention mainly uses a common e-mail transfer protocol to send and receive electronic mails between service provider and service client, the server will inevitably face the problem where unauthorized users use the mail server to send out anonymous or impostor emails, or that the recipients are unable to reject SPAM or emails infected by viruses. The security control mechanism is thus fairly significant to enhance stability and practicability of the present invention. Considering the e-mail delivery mechanism utilized by both parties in the present invention, it is apparent for those skilled in the art that other available security control mechanisms can be applied accordingly to prevent system resources from being abused or hacked by unauthorized users.

In addition, the present embodiment also provides a backup server 160, which 160 is connected to the main server 140 and the local server 104 via the Internet, therefore forming a highly-redundant configuration of an EDM system with triple remote backups. In the present embodiment, the backup server 160 is mainly used to make complete backup of the data on the main server 140 so as to avoid the loss of data due to the malfunction of the main server 140. Furthermore, the backup server 160 not only makes a backup copy on the main server 140, but also replaces main server 140 and provides access to the local server 104 when the main server 140 is down, thus making the EDM system provided by the present invention is even more reliable.

In order to meet the clients' need for mobility, the clients may also access the main server 140 or transmit electronic documents to the main server via personal terminal 180 in an external environment 18. Whenever the data on the main server 140 is updated, the backup server 160 is immediately synchronized with the main server 140 to ensure data consistency between the two servers.

When retrieving the data on the EDM system, an open and friendly network interface is provided, including the Hypertext Transfer Protocol (HTTP), the Post Office Protocol 3 (POP3), the Internet Message Access Protocol (IMAP), the Message Application Programming Application (IMAP), and the browser that comes with the operating system, therefore all users are able to use any software programs that are compatible to those transfer protocols, such as any web browser or any e-mail client to access the servers. Besides, if a client accesses the data from an external environment 18, an account management method is deployed in the present invention to safeguard the data. Also, based on another preferred embodiment of the present invention, an IP address identifier, a media access control (MAC) or any hardware information can be utilized to monitor the users logged into the system.

It is apparent to those skilled in the art that not all of the features in the foregoing preferred embodiment are essential elements of the present invention. For example, the backup server 160 is not necessary to the present invention, even though there is no doubt that the existence of this backup feature substantially increases the reliability of this EDA system. The local server 104 is not a required component either, and yet it practically enhances the document retrieval speed and lowers the load on the network bandwidth for the service client. The foregoing general description and the following detailed description are exemplary only and are intended to provide further explanation of the invention as claimed.

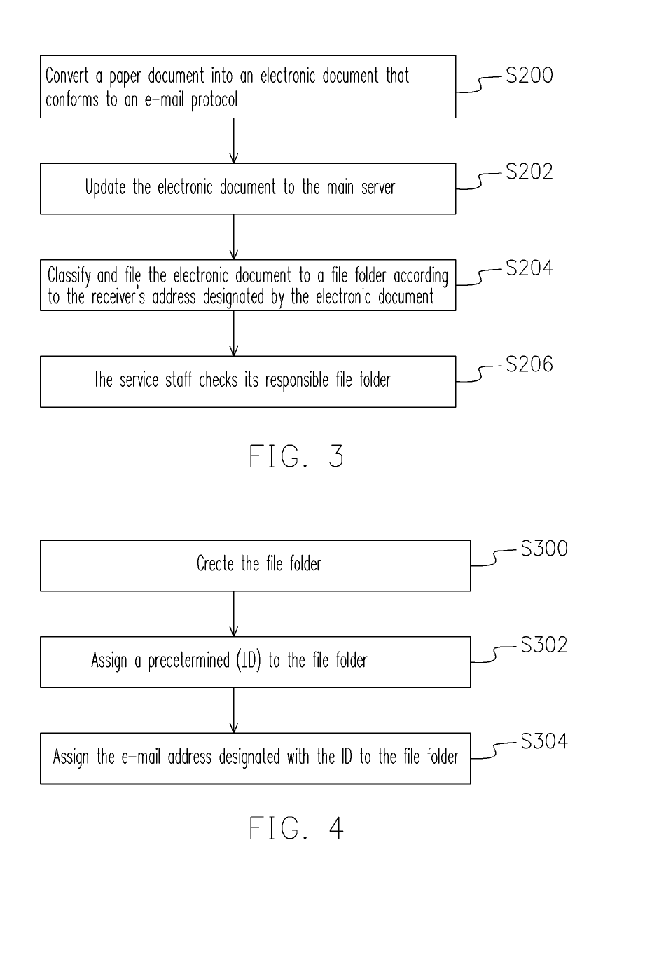

Referring to FIG. 3, it illustrates a flow chart for a method using synchronized backup technique for specialized outsourcing service of a preferred embodiment based on the present invention. FIG. 1 is referred hereby so as to describe this technique more clearly for those skilled in the art. The service client (referring to client terminal 10 in FIG. 1) firstly converts a printed document into an electronic document (S200) that is compliant with the e-mail encoding protocol. The electronic document is then transmitted to the main server 140 (S202). Notice that if there is more than one server (referring to the local server 104 and the backup server 160 in FIG. 2) available in the system, it is necessary to synchronize all the servers to ensure data consistency once an electronic document is transmitted to the main server. Additionally, the usage and volume of the file folders can be calculated and used for further communication with the clients.

Once the main server 140 of the service provider (referring to the professional service provider network 14 in FIG. 1) receives an electronic document, it classifies and files the document into a corresponding file folder based on the recipient's address (S204). Each of the staff of the service provider then retrieves the contents of the file folders to which he was assigned to manage outbound and inbound data and to provide professional consultation services promptly (S206).

FIG. 4 schematically shows a flow chart illustrating a p33p33corresponding method between an e-mail address and a file folder designed by a preferred embodiment according to the present invention. When a file folder is created (S300), the EDM system of the present invention assigns a predetermined and unique ID to the file folder (S 302), and this assigned ID then generates a corresponding e-mail address (S304). For example, if a file folder is created, and an ID is assigned to it as ID1, the corresponding email address is ID1@xxx.xxx. All e-mails sent to this address are saved in this file folder thereafter.

It will be apparent to those skilled in the art that besides using an ID, a certain string of characters and symbols can be used to further categorize and file the documents. Besides retrieving electronic documents from each corresponding file folders, this system also offers that the display of all electronic documents, i.e., the users may access all saved documents at once without opening each folder.

This feature allows users to manage the progress of the company's affairs by sorting the documents by date of receipt or storage.

In sum, it is not necessary to p35p35install proprietary application programs on clients' terminals, and all documents are securely and properly transmitted and stored according to the present invention. Moreover, it is fairly easy to control and manage the documents according to the present invention. All these features described above are not available in current EDM systems.

Although the invention has been described with reference to a particular embodiment thereof, it will be apparent to those skilled in the art that modifications to the described embodiment may be made without departing from the spirit of the invention. Accordingly, the scope of the invention will be defined by the attached claims and not by the above detailed description.

1. A method using a remote synchronized backup technique for outsourcing professional services between a service client and a service provider where a main server is installed on the service provider's end to transmit and categorize electronic documents, the method comprise of:
converting either a paper document or an electronic document of the service client into an electronic document conforming to an e-mail encoding protocol;
transmitting the electronic document to the main server via an e-mail transfer protocol; and
categorizing the electronic document according to its corresponding e-mail address in order to provide access to the service provider.

2. The method as recited in claim 1, wherein the main server creates a file folder for the electronic document, and a corresponding e-mail address is created accordingly.

3. The method as recited in claim 2, wherein the main server creates the file folder in the following steps:
creating the file folder and assigning an ID to the file folder; and
setting the ID of the file folder as the recipient of the e-mail address.

4. The method as recited in claim 1, further comprises of:
calculating a usage capacity of the file folder.

5. The method as recited in claim 1, further comprises of:
providing a backup server;
using the backup server to fully backup the data on the main server; and
accessing the backup server when the main server is down.

6. The method as recited in claim 1, further comprises of:
configuring a local server on the service client's end; and
synchronizing data between the main server and the local server to ensure data consistency and to facilitate high-speed local browsing.

7. The method as recited in claim 6, wherein the step of synchronizing the main server and the local server further comprises of:
updating the corresponding data on the local server as long whenever the user is updating the data stored in the file folder of the main server.

8. An electronic data management (EDM) system c8c8using the remote synchronized backup technique for outsourcing professional services, which comprises of:
a personal terminal to convert paper documents into electronic documents and to transmit the electronic documents via electronic mails; and
a main server to receive electronic documents and to store the electronic documents to a file folder based on the corresponding addresses assigned to the document.

9. The electronic data management (EDM) system as recited in claim 8, further comprises of:
a backup server for full data backup on the main server and for providing data c9c9access when the main server is down.

10. The electronic data management (EDM) system as recited in claim 8, wherein the main server further calculates a usage capacity of the file folder and a total capacity of multiple file folders.

11. The electronic data management (EDM) system as recited in claim 8, wherein the main server generates a corresponding e-mail address when a file folder is created.

12. The electronic data management (EDM) system as recited in claim 8, further comprises of a local server for transmitting electronic documents that complying with an e-mail transfer protocol.
